(19) United States
(12) Patent Application Publication
(10) Pub. No.: US 2025/0015910 A1
(43) Pub. Date: Jan. 9, 2025

(54) CHANNEL FEATURE INFORMATION TRANSMISSION METHOD AND APPARATUS, TERMINAL, AND NETWORK-SIDE DEVICE

(71) Applicant: VIVO MOBILE COMMUNICATION CO., LTD., Guangdong (CN)

(72) Inventors: Qianyao REN, Guangdong (CN); Tian XIE, Guangdong (CN)

(73) Assignee: VIVO MOBILE COMMUNICATION CO., LTD., Guangdong (CN)

(21) Appl. No.: 18/891,104

(22) Filed: Sep. 20, 2024

Related U.S. Application Data
(63) Continuation of application No. PCT/CN2023/082038, filed on Mar. 17, 2023.

(30) Foreign Application Priority Data
Mar. 21, 2022 (CN) 202210283866.2

(51) Int. Cl. H04B 17/391; H04B 7/06; H04W 72/231

(52) U.S. Cl. CPC H04B 17/3913; H04B 7/0626; H04B 7/06968; H04W 72/231

(57) ABSTRACT

This application discloses a channel feature information transmission method and apparatus, a terminal, and a network-side device. The channel feature information transmission method in embodiments of this application includes: receiving, by a terminal, first indication information, and generating first channel feature information based on a first artificial intelligence AI network model; determining, by the terminal, target channel feature information based on the first indication information and the first channel feature information, where the first channel feature information includes the target channel feature information; and reporting, by the terminal, the target channel feature information.

### CROSS-REFERENCE TO RELATED APPLICATIONS

This application is a Bypass Continuation Application of PCT International Application No. PCT/CN2023/082038 filed on Mar. 17, 2023, which claims priority to Chinese Patent Application No. 202210283866.2, filed in China on Mar. 21, 2022, which is incorporated herein by reference in its entirety.

### TECHNICAL FIELD

This application pertains to the field of communication technologies, and specifically, relates to a channel feature information transmission method and apparatus, a terminal, and a network-side device.

### BACKGROUND OF THE INVENTION

With development of science and technology, people have begun to study application of an artificial intelligence (AI) network model in a communication system. For example, communication data may be transmitted between a network-side device and a terminal based on the AI network model. Currently, in an AI-based channel state information (CSI) compression and feedback solution, CSI is compressed and encoded on a terminal, and compressed content is decoded on a network side to restore the CSI. In this case, a decoding network on the network side and an encoding network on the terminal side need to be jointly trained to achieve a proper degree of matching. However, compressed CSI with different lengths usually corresponds to different encoding networks and decoding networks. Consequently, a plurality of encoding networks and decoding networks need to be trained, and power consumption on the terminal side and the network side also increases correspondingly.

### SUMMARY OF THE INVENTION

According to a first aspect, a channel feature information transmission method is provided, including:

receiving, by a terminal, first indication information, and generating first channel feature information based on a first artificial intelligence AI network model;

determining, by the terminal, target channel feature information based on the first indication information and the first channel feature information, where the first channel feature information includes the target channel feature information; and reporting, by the terminal, the target channel feature information.

According to a second aspect, a channel feature information transmission method is provided, including:
sending, by a network-side device, first indication information to a terminal; and
receiving, by the network-side device, target channel feature information reported by the terminal, where
the target channel feature information is channel feature information determined by the terminal based on the first indication information and first channel feature information generated based on a first AI network model, and the first channel feature information includes the target channel feature information.

According to a third aspect, a channel feature information transmission apparatus is provided, including:
a first receiving module, configured to receive first indication information, and generate first channel feature information based on a first artificial intelligence AI network model;
a determining module, configured to determine target channel feature information based on the first indication information and the first channel feature information, where the first channel feature information includes the target channel feature information; and
a reporting module, configured to report the target channel feature information.

According to a fourth aspect, a channel feature information transmission apparatus is provided, including:
a sending module, configured to send first indication information to a terminal; and
a second receiving module, configured to receive target channel feature information reported by the terminal, where
the target channel feature information is channel feature information determined by the terminal based on the first indication information and first channel feature information generated based on a first AI network model, and the first channel feature information includes the target channel feature information.

According to a fifth aspect, a terminal is provided, where the terminal includes a processor and a memory, the memory stores a program or instructions capable of running on the processor, and when the program or instructions are executed by the processor, the steps of the channel feature information transmission method according to the first aspect are implemented.

According to a sixth aspect, a terminal is provided, including a processor and a communication interface. The communication interface is configured to receive first indication information. The processor is configured to generate first channel feature information based on a first artificial intelligence AI network model, and determine target channel feature information based on the first indication information and the first channel feature information, where the first channel feature information includes the target channel feature information. The communication interface is further configured to report the target channel feature information.

According to a seventh aspect, a network-side device is provided, where the network-side device includes a processor and a memory, the memory stores a program or instructions capable of running on the processor, and when the program or instructions are executed by the processor, the steps of the channel feature information transmission method according to the second aspect are implemented.

According to an eighth aspect, a network-side device is provided, including a processor and a communication interface. The communication interface is configured to send first indication information to a terminal, and receive target channel feature information reported by the terminal, where the target channel feature information is channel feature information determined by the terminal based on the first indication information and first channel feature information generated based on a first AI network model, and the first channel feature information includes the target channel feature information.

According to a ninth aspect, a communication system is provided, including a terminal and a network-side device, where the terminal may be configured to perform the steps of the channel feature information transmission method according to the first aspect, and the network-side device may be configured to perform the steps of the channel feature information transmission method according to the second aspect.

According to a tenth aspect, a readable storage medium is provided, where the readable storage medium stores a program or instructions, and when the program or instructions are executed by a processor, the steps of the channel feature information transmission method according to the first aspect are implemented, or the steps of the channel feature information transmission method according to the second aspect are implemented.

According to an eleventh aspect, a chip is provided, where the chip includes a processor and a communication interface, the communication interface is coupled to the processor, and the processor is configured to run a program or instructions, to implement the channel feature information transmission method according to the first aspect, or implement the channel feature information transmission method according to the second aspect.

According to a twelfth aspect, a computer program or program product is provided, where the computer program or program product is stored in a storage medium, and the computer program or program product is executed by at least one processor to implement the channel feature information transmission method according to the first aspect, or implement the channel feature information transmission method according to the second aspect.

### BRIEF DESCRIPTION OF DRAWINGS

FIG. 1 is a block diagram of a wireless communication system to which embodiments of this application are applicable;

FIG. 2 is a flowchart of a channel feature information transmission method according to an embodiment of this application;

FIG. 3 is a flowchart of another channel feature information transmission method according to an embodiment of this application;

FIG. 4 is a structural diagram of a channel feature information transmission apparatus according to an embodiment of this application;

FIG. 5 is a structural diagram of another channel feature information transmission apparatus according to an embodiment of this application;

FIG. 6 is a structural diagram of a communication device according to an embodiment of this application;

FIG. 7 is a structural diagram of a terminal according to an embodiment of this application; and

FIG. 8 is a structural diagram of a network-side device according to an embodiment of this application.

### DETAILED DESCRIPTION OF THE INVENTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a long term evolution (LTE)/LTE-advanced (LTE-A) system, and may be further used in other wireless communication systems, such as code division multiple access (CDMA), time division multiple access (TDMA), frequency division multiple access (FDMA), orthogonal frequency division multiple access (OFDMA), single-carrier frequency division multiple access (SC-FDMA), and other systems. The terms “system” and “network” in the embodiments of this application are often used interchangeably, and the technology described herein may be used in the aforementioned systems and radio technologies as well as other systems and radio technologies. In the following descriptions, a new radio (NR) system is described for an illustration purpose, and NR terms are used in most of the following descriptions. However, these technologies may also be applied to applications other than an NR system application, for example, a 6th generation (6G) communication system.

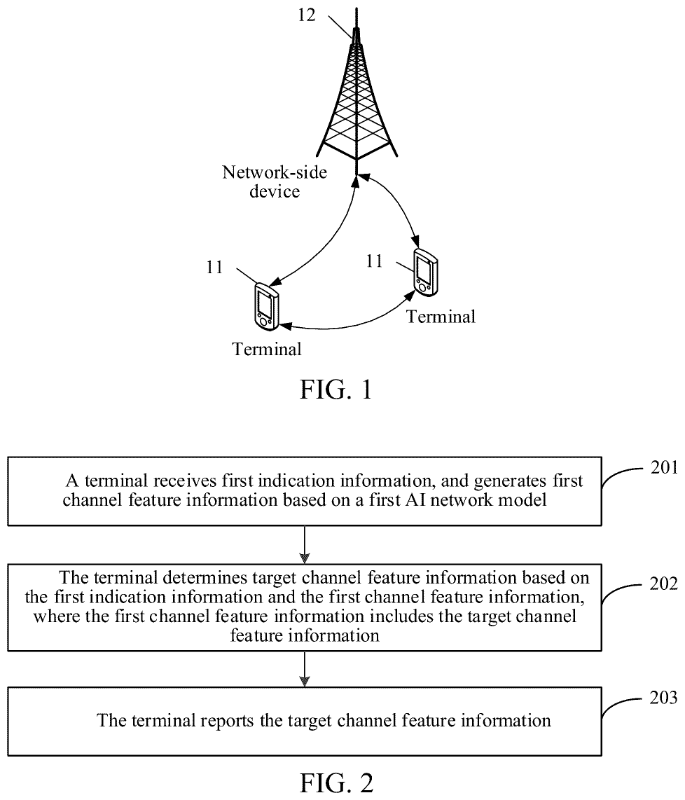

FIG. 1 is a block diagram of a wireless communication system to which embodiments of this application are applicable. The wireless communication system includes a terminal 11 and a network-side device 12. The terminal 11 may be a terminal-side device such as a mobile phone, a tablet personal computer, a laptop computer or referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (a home appliance with a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the art. Provided that the same technical effect is achieved, the base station is not limited to a specific technical term. It should be noted that the base station in the NR system is used only as an example for description in the embodiments of this application, but a specific type of the base station is not limited.

To better understand the technical solutions in this application, related concepts that may be included in the embodiments of this application are described below.

According to the information theory, accurate channel state information (CSI) is crucial to a channel capacity. Particularly, for a multiple-input multiple-output system, a transmit end may optimize sending of a signal based on CSI, so that the signal better matches a channel state. For example, a channel quality indicator (CQI) may be used for selecting a suitable modulation and coding scheme (MCS) to achieve link adaptation; and a precoding matrix indicator (PMI) may be used to implement eigen beamforming to maximize strength of a received signal, or suppress interference (for example, interference between cells or interference between a plurality of users). Therefore, CSI acquisition has been a research hotspot since a multiple-input multiple-output (MIMO) technology was proposed.

Usually, a network-side device (for example, a base stations) sends a CSI reference signal (CSI-RS) on some time-frequency resources in a specific slot. A terminal performs channel estimation based on the CSI-RS, calculates channel information in the slot, and feeds back a PMI to the base station by using a codebook. The base station obtains channel information through combination based on codebook information fed back by the terminal. Before next CSI reporting, the base station performs data precoding and multi-user scheduling based on the channel information.

To further reduce CSI feedback overheads, the terminal may change PMI reporting on each subband to PMI reporting based on a delay. Because channels in delay domain are more concentrated, PMIs on all subbands can be approximately represented by fewer delayed PMIs. To be specific, delay-domain information is compressed before being reported.

Similarly, to reduce overheads, the base station may precode the CSI-RS in advance, and send an encoded CSI-RS to the terminal. The terminal learns of a channel corresponding to the encoded CSI-RS. The terminal only needs to select several ports with high strength from ports indicated by a network side, and report coefficients corresponding to the ports.

Further, a neural network or a machine learning method may be used to better compress channel information. Specifically, the terminal compresses and encodes the channel information by using an AI network model, and the base station decodes compressed content by using an AI network model to restore the channel information. In this case, the AI network model used by the base station for decoding and the AI network model used by the terminal for encoding need to be jointly trained to achieve a proper degree of matching. The AI network model used by the terminal for encoding and the AI network model used by the base station for decoding constitute a joint neural network model, and are jointly trained by the network side. After training is completed, the base station sends an AI network model for encoding to the terminal.

The terminal estimates a CSI-RS, calculates channel information, inputs the calculated channel information or original estimated channel information to the AI network model to obtain an encoding result, and sends the encoding result to the base station. The base station receives the encoding result, and inputs the encoding result to the AI network model for decoding to restore the channel information.

In different channel environments, a degree of compression and encoding of channel information varies, and a length of encoded information also varies. To achieve target compression performance, simple channel information requires only a quite small encoding length, but complex channel information requires a large encoding length. Usually, encoded information with different lengths correspond to different AI network models. Therefore, a plurality of AI network models are required for processing for different compression bit lengths. Consequently, the terminal and the network side need to train and configure a plurality of AI network models.

The following describes in detail a channel feature information transmission method provided in the embodiments of this application with reference to the accompanying drawings and by using some embodiments and application scenarios thereof.

FIG. 2 is a flowchart of a channel feature information transmission method according to an embodiment of this application. The method is performed by a terminal. As shown in FIG. 2, the method includes the following steps.

Step 201: The terminal receives first indication information, and generates first channel feature information based on a first AI network model.

In this embodiment of this application, the terminal receives the first indication information sent by a network-side device, where the first indication information may be used to indicate a length and/or a location of channel feature information to be reported by the terminal, so that the terminal can perform an operation, such as truncation or selection, on the first channel feature information based on the first indication information to determine information content and a length of channel feature information that needs to be reported.

Optionally, the first channel feature information may be channel state information (CSI) or other information related to channel information. The terminal may detect a CSI reference signal (CSI-RS) or a tracking reference signal (TRS) at a location specified by the network-side device, and perform channel estimation to obtain channel information, and may input the channel information to the first AI network model to compress and encode the channel information (for example, a channel matrix for each subband or a precoding matrix for each subband) through the first AI network model to obtain the first channel feature information output by the first AI network model. It should be noted that channel information encoding mentioned in this embodiment of this application is different from channel encoding.

Optionally, a sequence of a process of receiving the first indication information by the terminal and a process of generating the first channel feature information by the terminal based on the first AI network model is not limited. For example, the terminal may generate the first channel feature information based on the first AI network model after receiving the first indication information, or may generate the first channel feature information based on the first AI network model and then receive the first indication information; or the two processes may be performed simultaneously.

Step 202: The terminal determines target channel feature information based on the first indication information and the first channel feature information, where the first channel feature information includes the target channel feature information.

In this embodiment of this application, after the terminal receives the first indication information and obtains the first channel feature information, the terminal determines the target channel feature information based on the first indication information and the first channel feature information. Optionally, the first indication information is used to indicate a length of the target channel feature information that the terminal needs to report. In this case, the terminal may perform truncation, or referred to as selection, on the first channel feature information based on the first indication information to obtain the target channel feature information, where a length of the target channel feature information is less than or equal to a length of the first channel feature information.

For example, the length of the first channel feature information is N, the first indication information is used to indicate the terminal to report channel feature information with a length of M, and M is less than N. In this case, the terminal captures channel feature information with a length of M from the first channel feature information with a length of N based on the first indication information as the target channel feature information. To be specific, the target channel feature information includes some or all of content of the first channel feature information.

Optionally, the terminal may truncate the first channel feature information in a specific truncation manner. For example, the terminal may capture channel feature information with a length of M from the first channel feature information in an order of front to back; or the terminal may randomly capture channel feature information with a length of M from the first channel feature information.

Step 203: The terminal reports the target channel feature information.

It can be understood that the terminal reports the target channel feature information to the network-side device after the terminal determines the target channel feature information from the first channel feature information based on the first indication information.

In this embodiment of this application, the terminal processes the channel information by using the first AI network model to obtain the first channel feature information output by the first AI network model, and can determine the target channel feature information from the first channel feature information based on the first indication information, and then report the target channel feature information to the network-side device. The length of the target channel feature information is less than or equal to the length of the first channel feature information. In this way, the terminal can process the channel information by using only one AI network model, and then flexibly obtain target channel feature information with different lengths based on the first indication information, without configuring a corresponding AI network model for channel feature information with each length, so that a capacity and power of the terminal can be effectively saved.

Optionally, the first indication information is used to indicate at least one of the following:
a length of the target channel feature information;
a length range of the target channel feature information;
a table index of a length of the target channel feature information; or
a location of the target channel feature information.

For example, the first indication information is used to indicate the length of the target channel feature information, so that the terminal can truncate the first channel feature information based on the first indication information to obtain the target channel feature information with the length indicated by the first indication information. Alternatively, the first indication information is used to indicate the length range of the target channel feature information, so that the terminal truncates the first channel feature information based on the first indication information to obtain the target channel feature information, where a length of the target channel feature information falls within the length range indicated by the first indication information. Alternatively, the first indication information is used to indicate the table index of the length of the target channel feature information. The terminal may truncate the first channel feature information based on the table index to obtain the target channel feature information, where a length of the target channel feature information is a length corresponding to the table index. Alternatively, the first indication information may indicate the location of the target channel feature information. The terminal captures channel feature information at a specific location in the first channel feature information based on the indicated location to obtain the target channel feature information. Alternatively, the first indication information may be used to indicate the length and the location of the target channel feature information, or indicate the length range and the location of the target channel feature information, or the like. No more examples are provided in this embodiment.

It should be noted that output of an AI network model is a vector, an element of the vector is the number of bits or a coefficient, and the coefficient needs to be quantized to generate a corresponding bitstream for reporting; or an AI network model may output quantized bits, so that the terminal finally reports bits. In this embodiment of this application, the truncation performed by the terminal on the first channel feature information may be performed on a vector output by the first AI network model. Therefore, the length may be the number of bits or the number of coefficients. If the length is the number of coefficients, the terminal captures coefficients, quantizes captured coefficients, and then reports quantized coefficients. If the length is the number of bits, the terminal captures bits and then reports captured bits.

In this embodiment of this application, based on indication content of the first indication information, the terminal can perform targeted truncation on the first channel feature information based on the first indication information to obtain the target channel feature information, so that the terminal can process the channel information by configuring only one AI network model.

Optionally, the length of the target channel feature information is represented by at least one of the following:
an absolute length;
a preset proportion of a target length, where the target length is a maximum length of the first channel feature information generated based on the first AI network model; and
the number of base lengths, where the base length is agreed upon in a protocol.

It should be noted that the absolute length may be a specified length, for example, 200 bits, 180 bits, or 160 bits.

The target length is a maximum length of the first channel feature information. In other words, the target length is an output length of the first AI network model, namely, the length of the first channel feature information. Therefore, the target length is a fixed value. The first indication information may indicate a preset proportion of the target length to represent the length of the target channel feature information. For example, the first indication information indicates that the length of the target channel feature information is 100%, 90%, or 80% of the target length.

The base length is pre-agreed upon in a protocol. The first indication information may indicate the number of base lengths to represent the length of the target channel feature information. For example, the base length is 50 bits, and the first indication information indicates two base lengths, to be specific, indicates that the length of the target channel feature information is 100 bits.

In this embodiment of this application, the first indication information includes at least one of the following:
radio resource control (RRC) signaling;
medium access control control element (MAC CE) signaling; or
downlink control information (DCI).

For example, the network-side device uses RRC signaling or MAC CE signaling to configure the length of the target channel feature information through, or configure the table index of the length of the target channel feature information, for example, a CSI report configuration (CSI report config) file, or configure the length range or the location of the target channel feature information. Alternatively, the network-side device may dynamically indicate the length of the target channel feature information or the table index of the length of the target channel feature information by using DCI. That is, the network-side device may perform explicit indication to represent content of the first indication information.

Optionally, the network-side device may alternatively perform implicit indication to represent content of the first indication information. In a case that the first indication information performs implicit indication by using signaling, the first indication information is associated by using a CSI report configuration file, and the first indication information includes the table index of the length of the target channel feature information. For example, the network-side device sends a CSI report configuration file to the terminal. The CSI report configuration file is associated with the table index of the length of the target channel feature information, and therefore may indicate the length of the target channel feature information to the terminal.

The table index of the length of the target channel feature information is agreed upon in a protocol.

Optionally, in the table index of the length of the target channel feature information, one length of the target channel feature information corresponds to at least one parameter. The parameter is related to at least one of the following:
the CSI report configuration file; or
a configuration of another reference signal that meets a quasi co-location (QCL) relationship with a CSI reference signal (CSI-RS).

In this embodiment of this application, in a case that the first indication information is associated by using the CSI report configuration file, the first indication information includes the table index of the length of the target channel feature information, where one length of the target channel feature information corresponds to one parameter, or may correspond to a combination of a plurality of parameters. For example, the parameter is the number of CSI-RS ports. For example, 32 ports correspond to 200 bits, and 16 ports correspond to 180 bits. For another example, the parameter may alternatively be the number of CSI-RS resources or CSI-RS density. For example, higher configured CSI-RS density corresponds a larger length of the target channel feature information. Certainly, the parameter may alternatively be another parameter related to the CSI report configuration file, or a configuration, for example, a code division mode, of another reference signal that meets a QCL relationship with a CSI-RS. Specific examples are not provided in this embodiment.

In this embodiment of this application, the first indication information is further used to indicate a payload size, and that the terminal determines target channel feature information based on the first indication information and the first channel feature information includes:

The terminal determines the payload size based on the first indication information; and
the terminal determines the length of the target channel feature information based on the payload size.

It should be noted that the first indication information may alternatively be implicitly indicated by the payload size configured by the network-side device. In this case, the terminal determines the length of the target channel feature information based on the payload size. In this way, the network-side device can more flexibly indicate the length of the target channel feature information to the terminal.

Optionally, the payload size is determined based on uplink resource and bit rate sizes configured by the network-side device. For example, the network-side device configures physical uplink control channel (PUCCH) and/or physical uplink shared channel (PUSCH) resource and bit rate sizes. The terminal calculates the payload size based on the uplink resource and bit rate sizes, and determines the length of the target channel feature information based on the payload size.

In this embodiment of this application, the network-side device may indicate content of the first indication information through explicit indication or implicit indication, so that the network-side device can flexibly configure the first indication information.

In this embodiment of this application, that the terminal reports the target channel feature information includes:

The terminal reports information content of the target channel feature information and the length of the target channel feature information.

For example, the terminal simultaneously reports the information content and the length of the target channel feature information. In this way, the network-side device can learn of, based on the reporting by the terminal, the length of the target channel feature information to be decoded, and in a case that the network-side device includes a plurality of second AI network models, the network-side device can select a corresponding second AI network model based on the length of the target channel feature information for decoding to restore the channel information.

Optionally, the first indication information is further used to indicate the terminal to report the length of the target channel feature information. To be specific, the network-side device may configure the terminal to report the length of the target channel feature information while feeding back the target channel feature information.

In this embodiment of this application, the terminal may have a plurality of first AI network models. Optionally, the terminal includes L first AI network models, and L is a positive integer, where any one of the L first AI network models corresponds to at least one length of the target channel feature information; or the L first AI network models are in a one-to-one correspondence with L length ranges of the target channel feature information.

For example, the terminal includes L first AI network models, each first AI network model corresponds to one length of first channel feature information, for example, N1, N2, . . . , NL, and each first AI network model corresponds to K lengths of the target channel feature information, for example, Mi1, Mi2, . . . , MiK, where i represents an i^{th} first AI network model, a value of i ranges from 1 to L, and j represents a j^{th} length of the target channel feature information. Different first AI network models may correspond to different numbers of lengths of the target channel feature information. To be specific, Mi1 to Mik are different or partially overlap. Optionally, N1 to NL may be the same, and Mij may also be the same.

For example, the terminal includes two first AI network models, and lengths corresponding to all first channel feature information are 200 bits, where lengths that are of the target channel feature information and that correspond to the 1^{st} first AI network model are 200 bits, 180 bits, and 160 bits, and lengths that are of the target channel feature information and that correspond to the 2^{nd} first AI network model are 140 bits, 120 bits, 100 bits, and 80 bits. The terminal may select a corresponding first AI network model based on the first indication information to truncate the first channel feature information. For example, if a length that is of the target channel feature information and that is indicated by the first indication information is 160 bits, the terminal selects the 1st first AI network model to process the channel information.

Alternatively, the terminal includes L first AI network models, each first AI network model corresponds to one length range of the target channel feature information, and these length ranges of the target channel feature information are different. For example, a first AI network model N1 corresponds to a length range of 160 bits to 200 bits, and a first AI network model N2 corresponds to a length range of 130 bits to 160 bits.

Optionally, a correspondence between any one of the L first AI network models and a length of the target channel feature information is configured by the network-side device; or a correspondence between the L first AI network models and the L length ranges of the target channel feature information is configured by the network-side device.

Optionally, in a case that the first indication information includes the length of the target channel feature information, that the terminal determines target channel feature information based on the first indication information and the first channel feature information includes:

The terminal determines a corresponding target first AI network model based on the length that is of the target channel feature information and that is indicated by the first indication information, and determines, based on the target first AI network model and the length of the target channel feature information, target channel feature information that needs to be reported; or
the terminal determines, based on the length that is of the target channel feature information and that is indicated by the first indication information, a length range of the target channel feature information to which the length belongs, determines a corresponding target first AI network model based on the length range of the target channel feature information, and determines, based on the target first AI network model and the length of the target channel feature information, target channel feature information that needs to be reported.

For example, the first indication information indicates that the length of the target channel feature information is 180 bits. If the terminal includes two first AI network models, lengths that are of the target channel feature information and that correspond to a first AI network model N1 are 200 bits, 180 bits, and 160 bits, and lengths that are of the target channel feature information and that correspond to a first AI network model N2 are 140 bits, 120 bits, 100 bits, and 80 bits, the terminal determines the first AI network model N1 as the target first AI network model. Alternatively, if a length range that is of the target channel feature information and that corresponds to the first AI network model N1 is 160 bits to 200 bits and a length range that is of the target channel feature information and that corresponds to the first AI network model N2 is 130 bits to 160 bits, the terminal determines the first AI network model N1 as the target first AI network model. Further, the terminal processes the channel information based on the target first AI network model to obtain the first channel feature information, and truncates the first channel feature information based on the length indicated by the first indication information to obtain the target channel feature information.

Optionally, in a case that the first indication information indicates a target length of the target channel feature information, and at least one length that is of the target channel feature information and that corresponds to each of at least two of the L first AI network models or a length range that is of the target channel feature information and that corresponds to each of the at least two first AI network models includes the target length, that the terminal determines target channel feature information based on the first indication information and the first channel feature information includes:

The terminal selects a target first AI network model based on the target length, and determines, based on the target first AI network model and the target length, target channel feature information that needs to be reported, where the target first AI network model is any one of the at least two first AI network models.

In this embodiment of this application, the terminal may include a plurality of first AI network models, and lengths that are of the target channel feature information and that correspond to the plurality of first AI network models may be the same, or length ranges that are of the target channel feature information and that correspond to the plurality of first AI network models may overlap. In a case that the first indication information indicates the target length of the target channel feature information, the target length may correspond to two or more first AI network models. The terminal may select one of the first AI network models as the target first AI network model to process the channel information to generate the first channel feature information. Then the terminal can truncate the first channel feature information based on the target length to obtain the target channel feature information.

For example, the terminal may select the target first AI network model randomly, or based on indication by the network-side device, or based on a priority order of first AI network models.

Optionally, that the terminal selects a target first AI network model based on the target length includes either of the following:

The terminal selects the target first AI network model based on the target length and priorities of the at least two first AI network models; or
in a case that the first indication information is further used to indicate the target first AI network model, the terminal selects the target first AI network model based on the first indication information.

For example, the at least two first AI network models corresponding to the target length include respective corresponding priorities, and the priorities may be preconfigured by the network-side device. The terminal may preferentially select a first AI network model with a higher priority in descending order of priorities. In this way, the terminal can purposefully select and determine the target first AI network model.

Output lengths of all first AI network models may be sorted, and a first AI network model with a small length is preferentially selected as the target first AI network model. For example, the terminal includes two first AI network models, lengths that are of the target channel feature information and that correspond to a first AI network model N1 are 200 bits, 180 bits, and 160 bits, an output length of N1 is 200 bits, lengths that are of the target channel feature information and that correspond to the other first AI network model N2 are 160 bits, 140 bits, and 120 bits, and an output length of N2 is 160 bits. If the first indication information indicates that the length of the reported target channel feature information is 160 bits, the terminal preferentially selects N2 as the target first AI network model.

Alternatively, differences between the length that is of the target channel feature information and that is indicated by the first indication information and output lengths of all first AI network models may be sorted, and a first AI network model with a small difference is preferentially selected as the target first AI network model.

Alternatively, the numbers of pieces of channel feature information that can be respectively captured based on output lengths of all first AI network models may be sorted, and a first AI network model with a small number of pieces of captured channel feature information is preferentially selected as the target first AI network model. Alternatively, the first indication information configured by the network-side device may directly indicate the target first AI network model. In this way, the terminal can determine the target first AI network model based on the first indication information, and the terminal does not need to perform selection from a plurality of first AI network models. This simplifies a process for the terminal.

Optionally, that the terminal reports the target channel feature information includes:

The terminal reports the target channel feature information and an index corresponding to the target first AI network model.

It should be noted that in a case that the terminal includes a plurality of first AI network models, each first AI network model may include a corresponding index, and a correspondence between a first AI network model and its index may be pre-agreed upon between the terminal and the network-side device. In a case that the terminal processes the channel information based on the target first AI network model, the terminal may further report an index of the target first AI network model while reporting the target channel feature information, so that the network-side device can determine, based on the reported index, the target first AI network model used by the terminal, and the network-side device can select a second AI network model corresponding to the target first AI network model to decode the target channel feature information to restore the channel information.

In this embodiment of this application, the network-side device may be configured with second AI network models whose number is the same as the number of first AI network models on the terminal, one first AI network model corresponds to one second AI network model, a first AI network model and a second AI network model that correspond to each other are jointly trained by the network-side device, and then the network-side device sends a trained first AI network model to the terminal. The terminal encodes channel information by using the first AI network model to generate first channel feature information, truncates the first channel feature information based on the first indication information to obtain target channel feature information, and reports the target channel feature information to the network-side device. The network-side device selects a second AI network model corresponding to the first AI network model used by the terminal to decode the target channel feature information to obtain channel information output by the second AI network model, so as to restore the channel information. In this way, the channel information can be encoded and decoded by the AI network models.

The L first AI network models on the terminal may respectively correspond to different lengths or length ranges of the target channel feature information. Correspondingly, L second AI network models on the network-side device may also respectively correspond to different lengths or length ranges of the target channel feature information, to correspond to the first AI network models. In this way, the network-side device can select a corresponding second AI network model based on a length of the target channel feature information for processing, to avoid a problem that all target channel feature information is processed by one second AI network model, causing loss of the second AI network model and affecting decoding performance. A plurality of second AI network models are configured, so that processing performance of the network-side device for channel information can be better ensured.

The channel feature information transmission method provided in this application is described below by using a specific embodiment.
1. A terminal detects a CSI-RS or a TRS at a location specified by a network-side device, and performs channel estimation to obtain channel information.
2. The terminal encodes the channel information into CSI information by using a first AI network model.
3. The terminal selects a part of the CSI information as to-be-reported CSI information based on first indication information.
4. The terminal combines the to-be-reported CSI information and other control information into uplink control information (UCI), or uses the to-be-reported CSI information as UCI.
5. The terminal splits the UCI based on a length of the UCI, and adds a cyclic redundancy check (CRC) bit.
6. The terminal performs operations of channel encoding, rate matching, and code block association.
7. The terminal maps the UCI to a PUCCH or a PUSCH for reporting.

It should be noted that the foregoing steps are not limited, and some steps, for example, step 6, may be omitted. In this embodiment, the terminal can encode the channel information by using only one first AI network model, and then flexibly obtain CSI information with different lengths based on the first indication information, without configuring a corresponding AI network model for CSI information with each length, so that a capacity and power of the terminal can be effectively saved.

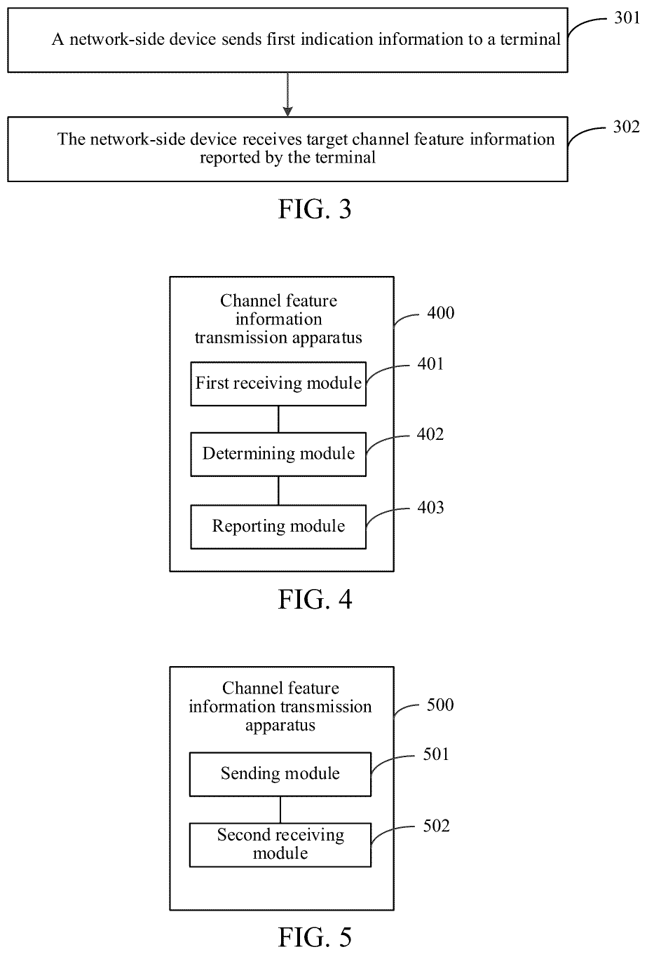

FIG. 3 is a flowchart of another channel feature information transmission method according to an embodiment of this application. The method is performed by a network-side device. As shown in FIG. 3, the method includes the following steps.

Step 301: The network-side device sends first indication information to a terminal.

Step 302: The network-side device receives target channel feature information reported by the terminal.

The target channel feature information is channel feature information determined by the terminal based on the first indication information and first channel feature information generated based on a first AI network model, and the first channel feature information includes the target channel feature information.

In this embodiment of this application, the network-side device sends the first indication information to the terminal, so that the terminal can truncate, based on the first indication information, the first channel feature information generated based on the first AI network model to obtain the target channel feature information, and report the target channel feature information. The network-side device receives the target channel feature information reported by the terminal. The network-side device inputs the target channel feature information to a second AI network model to obtain output channel information, so as to restore the channel information through the second AI network model. The second AI network model corresponds to the first AI network model. To be specific, the first AI network model and the second AI network model are obtained through joint training.

A length of the target channel feature information is less than or equal to a length of the first channel feature information. In this way, the terminal can process the channel information by using only one AI network model, and then flexibly obtain target channel feature information with different lengths based on the first indication information, without configuring a corresponding AI network model for channel feature information with each length, so that a capacity and power of the terminal are effectively saved.

Optionally, the first indication information is used to indicate at least one of the following:
a length of the target channel feature information;
a length range of the target channel feature information;
a table index of a length of the target channel feature information; or
a location of the target channel feature information.

Optionally, the length of the target channel feature information is represented by at least one of the following:
an absolute length;
a preset proportion of a target length, where the target length is a maximum length of the first channel feature information generated based on the first AI network model; and
the number of base lengths, where the base length is agreed upon in a protocol.

It should be noted that the network-side device may pre-agree with the terminal upon a representation manner for the length of the target channel feature information.

Optionally, the first indication information includes at least one of the following:
RRC signaling;
MAC CE signaling; or
DCI.

For example, the network-side device uses RRC signaling or MAC CE signaling to configure the length of the target channel feature information through, or configure the table index of the length of the target channel feature information, for example, a CSI report configuration (CSI report config) file, or configure the length range or the location of the target channel feature information. Alternatively, the network-side device may dynamically indicate the length of the target channel feature information or the table index of the length of the target channel feature information by using DCI. That is, the network-side device may perform explicit indication to represent content of the first indication information.

Optionally, the network-side device may alternatively perform implicit indication to represent content of the first indication information.

For example, the network-side device performs association on the first indication information by using a CSI report configuration file, and the first indication information includes the table index of the length of the target channel feature information. For example, the network-side device sends a CSI report configuration file to the terminal. The CSI report configuration file is associated with the table index of the length of the target channel feature information, to indicate the length of the target channel feature information to the terminal.

Optionally, the table index of the length of the target channel feature information is agreed upon in a protocol.

Optionally, in the table index of the length of the target channel feature information, one length of the target channel feature information corresponds to at least one parameter.

The parameter is related to at least one of the following:
the CSI report configuration file; or
a configuration of another reference signal that meets a QCL relationship with a CSI-RS.

In this embodiment of this application, in a case that the first indication information is associated by using the CSI report configuration file, the first indication information includes the table index of the length of the target channel feature information, where one length of the target channel feature information corresponds to one parameter, or may correspond to a combination of a plurality of parameters. For example, the parameter is the number of CSI-RS ports. For example, 32 ports correspond to 200 bits, and 16 ports correspond to 180 bits. For another example, the parameter may alternatively be the number of CSI-RS resources or CSI-RS density. For example, higher configured CSI-RS density corresponds a larger length of the target channel feature information. Certainly, the parameter may alternatively be another parameter related to the CSI report configuration file, or a configuration, for example, a code division mode, of another reference signal that meets a QCL relationship with a CSI-RS. Specific examples are not provided in this embodiment.

Optionally, the first indication information is further used to indicate a payload size, and the terminal is configured to determine a first length of the target channel feature information based on the payload size.

Optionally, the network-side device determines the payload size by configuring uplink resource and bit rate sizes. For example, the network-side device configures physical uplink control channel (PUCCH) and/or physical uplink shared channel (PUSCH) resource and bit rate sizes. The terminal calculates the payload size based on the uplink resource and bit rate sizes, and determines the length of the target channel feature information based on the payload size.

Optionally, that the network-side device receives target channel feature information reported by the terminal includes:

The network-side device receives information content of the target channel feature information and a length of the target channel feature information that are reported by the terminal.

For example, the terminal simultaneously reports the information content and the length of the target channel feature information. In this way, the network-side device can learn of, based on the reporting by the terminal, the length of the target channel feature information to be decoded, and in a case that the network-side device includes a plurality of second AI network models, the network-side device can select a corresponding second AI network model based on the length of the target feature information for decoding to restore the channel information.

Optionally, the first indication information is further used to indicate the terminal to report the length of the target channel feature information.

Optionally, the terminal includes L first AI network models, L is a positive integer, and the method further includes at least one of the following:

The network-side device configures a correspondence between any one of the L first AI network models and a length of the target channel feature information; or the network-side device configures a correspondence between the L first AI network models and L length ranges of the target channel feature information, where the L first AI network models are in a one-to-one correspondence with the L length ranges of the target channel feature information.

In this embodiment of this application, in a case that the first indication information indicates a target length of the target channel feature information, and at least one length that is of the target channel feature information and that corresponds to each of at least two of the L first AI network models or a length range that is of the target channel feature information and that corresponds to each of the at least two first AI network models includes the target length, that the network-side device receives target channel feature information reported by the terminal includes:

The network-side device receives the target channel feature information reported by the terminal and an index corresponding to a target first AI network model, where the target first AI network model is any one of the at least two first AI network models.

Optionally, the first indication information is further used to indicate the target first AI network model.

It should be noted that in a case that the terminal includes L first AI network models, the network-side device also correspondingly includes L second AI network models, the L first AI network models are in a one-to-one correspondence with the L second AI network models, and a first AI network model and a second AI network model that correspond to each other are jointly trained by the network-side device. For example, the terminal encodes the channel information based on a first AI network model N1. In a case that the network-side device receives the target channel feature information, the network-side device inputs the target channel feature information to a second AI network model corresponding to the first AI network model N1 for decoding to output channel information, so as to restore the channel information.

Optionally, the L first AI network models on the terminal may respectively correspond to different lengths or length ranges of the target channel feature information. Correspondingly, the L second AI network models on the network-side device may also respectively correspond to different lengths or length ranges of the target channel feature information, to correspond to the first AI network models. In this way, the network-side device can select a corresponding second AI network model based on a length of the target channel feature information for processing, to avoid a problem that all target channel feature information is processed by one second AI network model, causing loss of the second AI network model and affecting decoding performance. A plurality of second AI network models are configured, so that processing performance of the network-side device for channel information can be better ensured.

In this embodiment of this application, after receiving the target channel feature information, the network-side device may further truncate the target channel feature information based on an input length of the second AI network model. For example, the second AI network model uses 128-bit input, and the length of the target channel feature information reported by the terminal is 134 bits. In this case, the network-side device can further truncate the received target channel feature information to obtain 128-bit channel feature information, and input the 128-bit channel feature information to the second AI network model.

It should be noted that, in the foregoing case, the length of the target channel feature information that is calculated by the terminal based on the payload size may be different from the input length of the second AI network model. Alternatively, a length of the target channel feature information is agreed upon in a protocol, and the input length of the second AI network model used by the network-side device is different from that in the protocol. In this case, a base station may further truncate the target channel feature information to obtain a length suitable for input to the second AI network model. In this way, the network-side device can more flexibly process the target channel feature information.

The channel feature information transmission method provided in this embodiment of this application is applied to the network-side device. For related concepts and specific implementation processes thereof, refer to specific descriptions in the embodiment of the channel feature information transmission method applied to the terminal in FIG. 2. To avoid repetition, details are not described in this embodiment again.

The channel feature information transmission method provided in the embodiments of this application may be performed by a channel feature information transmission apparatus. In the embodiments of this application, a channel feature information transmission apparatus provided in the embodiments of this application is described by using an example in which the channel feature information transmission apparatus performs the channel feature information transmission method.

FIG. 4 shows a channel feature information transmission apparatus according to an embodiment of this application. As shown in FIG. 4, the channel feature information transmission apparatus 400 includes:
a first receiving module 401, configured to receive first indication information, and generate first channel feature information based on a first artificial intelligence AI network model;
a determining module 402, configured to determine target channel feature information based on the first indication information and the first channel feature information, where the first channel feature information includes the target channel feature information; and
a reporting module 403, configured to report the target channel feature information.

Optionally, the first indication information is used to indicate at least one of the following:
a length of the target channel feature information;
a length range of the target channel feature information;
a table index of a length of the target channel feature information; or
a location of the target channel feature information.

Optionally, the length of the target channel feature information is represented by at least one of the following:
an absolute length;
a preset proportion of a target length, where the target length is a maximum length of the first channel feature information generated based on the first AI network model; and
the number of base lengths, where the base length is agreed upon in a protocol.

Optionally, the first indication information includes at least one of the following:
RRC signaling;
MAC CE signaling; or
DCI.

Optionally, the first indication information is further used to indicate a payload size, and the determining module 402 is further configured to:
determine the payload size based on the first indication information; and
determine a first length of the target channel feature information based on the payload size.

Optionally, the payload size is determined based on uplink resource and bit rate sizes configured by a network-side device.

Optionally, in a case that the first indication information performs implicit indication by using signaling, the first indication information is associated by using a channel state information CSI report configuration file, and the first indication information includes the table index of the length of the target channel feature information.

Optionally, the table index of the length of the target channel feature information is agreed upon in a protocol.

Optionally, in the table index of the length of the target channel feature information, one length of the target channel feature information corresponds to at least one parameter.

The parameter is related to at least one of the following:
the CSI report configuration file; or
a configuration of another reference signal that meets a quasi co-location QCL relationship with a CSI reference signal CSI-RS.

Optionally, the reporting module 403 is further configured to:
report information content of the target channel feature information and the length of the target channel feature information.

Optionally, the first indication information is further used to indicate the apparatus to report the length of the target channel feature information.

Optionally, the apparatus includes L first AI network models, and L is a positive integer, where
any one of the L first AI network models corresponds to at least one length of the target channel feature information; or
the L first AI network models are in a one-to-one correspondence with L length ranges of the target channel feature information, and the L length ranges of the target channel feature information are different.

Optionally, a correspondence between any one of the L first AI network models and a length of the target channel feature information is configured by the network-side device; or
a correspondence between the L first AI network models and the L length ranges of the target channel feature information is configured by the network-side device.

Optionally, in a case that the first indication information includes the length of the target channel feature information, the determining module 402 is further configured to:
determine a corresponding target first AI network model based on the length that is of the target channel feature information and that is indicated by the first indication information, and determine, based on the target first AI network model and the length of the target channel feature information, target channel feature information that needs to be reported; or
determine, based on the length that is of the target channel feature information and that is indicated by the first indication information, a length range of the target channel feature information to which the length belongs, determine a corresponding target first AI network model based on the length range of the target channel feature information, and determine, based on the target first AI network model and the length of the target channel feature information, target channel feature information that needs to be reported.

Optionally, in a case that the first indication information indicates a target length of the target channel feature information, and at least one length that is of the target channel feature information and that corresponds to each of at least two of the L first AI network models or a length range that is of the target channel feature information and that corresponds to each of the at least two first AI network models includes the target length, the determining module 402 is further configured to:

select a target first AI network model based on the target length, and determine, based on the target first AI network model and the target length, target channel feature information that needs to be reported, where the target first AI network model is any one of the at least two first AI network models.

Optionally, the determining module 402 is further configured to perform any one of the following:
selecting the target first AI network model based on the target length and priorities of the at least two first AI network models; or
in a case that the first indication information is further used to indicate the target first AI network model, selecting the target first AI network model based on the first indication information.

Optionally, the reporting module 403 is further configured to:
report the target channel feature information and an index corresponding to the target first AI network model.

The apparatus provided in this embodiment of this application processes the channel information by using the first AI network model to obtain the first channel feature information output by the first AI network model, and can determine the target channel feature information from the first channel feature information based on the first indication information, and then report the target channel feature information to the network-side device. The first channel feature information includes the target channel feature information. The length of the target channel feature information is less than or equal to a length of the first channel feature information. In this way, the apparatus can process the channel information by using only one AI network model, and then flexibly obtain target channel feature information with different lengths based on the first indication information, without configuring a corresponding AI network model for channel feature information with each length, so that a capacity and power of the apparatus can be effectively saved.

The channel feature information transmission apparatus in this embodiment of this application may be an electronic device, for example, an electronic device with an operating system; or may be a component in an electronic device, for example, an integrated circuit or a chip. The electronic device may be a terminal or another device other than the terminal. For example, the terminal may include but is not limited to the aforementioned types of the terminal 11, and the another device may be a server, a network attached storage (NAS), or the like. This is not specifically limited in embodiments of this application.

The channel feature information transmission apparatus provided in this embodiment of this application is capable of implementing the processes implemented by the terminal in the method embodiment of FIG. 2, with the same technical effect achieved. To avoid repetition, details are not described herein again.

FIG. 5 shows another channel feature information transmission apparatus according to an embodiment of this application. As shown in FIG. 5, the channel feature information transmission apparatus 500 includes:
a sending module 501, configured to send first indication information to a terminal; and
a second receiving module 502, configured to receive target channel feature information reported by the terminal, where
the target channel feature information is channel feature information determined by the terminal based on the first indication information and first channel feature information generated based on a first AI network model, and the first channel feature information includes the target channel feature information.

Optionally, the first indication information is used to indicate at least one of the following:
a length of the target channel feature information;
a length range of the target channel feature information;
a table index of a length of the target channel feature information; or
a location of the target channel feature information.

Optionally, the length of the target channel feature information is represented by at least one of the following:
an absolute length;
a preset proportion of a target length, where the target length is a maximum length of the first channel feature information generated based on the first AI network model; and
the number of base lengths, where the base length is agreed upon in a protocol.

Optionally, the first indication information includes at least one of the following:
RRC signaling;
MAC CE signaling; or
DCI.

Optionally, the first indication information is further used to indicate a payload size, and the terminal is configured to determine a first length of the target channel feature information based on the payload size.

Optionally, the apparatus determines the payload size by configuring uplink resource and bit rate sizes.

Optionally, the apparatus performs association on the first indication information by using a CSI report configuration file, and the first indication information includes the table index of the length of the target channel feature information.

Optionally, the table index of the length of the target channel feature information is agreed upon in a protocol.

Optionally, in the table index of the length of the target channel feature information, one length of the target channel feature information corresponds to at least one parameter.

The parameter is related to at least one of the following:
the CSI report configuration file; or
a configuration of another reference signal that meets a quasi co-location QCL relationship with a CSI reference signal CSI-RS.

Optionally, the second receiving module 502 is further configured to:
receive information content of the target channel feature information and a length of the target channel feature information that are reported by the terminal.

Optionally, the first indication information is further used to indicate the terminal to report the length of the target channel feature information.

Optionally, the terminal includes L first AI network models, L is a positive integer, and the apparatus is further configured to perform at least one of the following:
configuring a correspondence between any one of the L first AI network models and a length of the target channel feature information; or
configuring a correspondence between the L first AI network models and L length ranges of the target channel feature information, where the L first AI network models are in a one-to-one correspondence with the L length ranges of the target channel feature information.

Optionally, in a case that the first indication information indicates a target length of the target channel feature information, and at least one length that is of the target channel feature information and that corresponds to each of at least two of the L first AI network models or a length range that is of the target channel feature information and that corresponds to each of the at least two first AI network models includes the target length, the second receiving module 502 is further configured to:
receive the target channel feature information reported by the terminal and an index corresponding to a target first AI network model, where the target first AI network model is any one of the at least two first AI network models.

Optionally, the first indication information is further used to indicate the target first AI network model.

In this embodiment of this application, the apparatus may be configured with only one second AI network model to process target channel feature information, to effectively save a capacity and power of the network-side device.

The channel feature information transmission apparatus provided in this embodiment of this application is capable of implementing the processes implemented by the network-side device in the method embodiment of FIG. 3, with the same technical effect achieved. To avoid repetition, details are not described herein again.

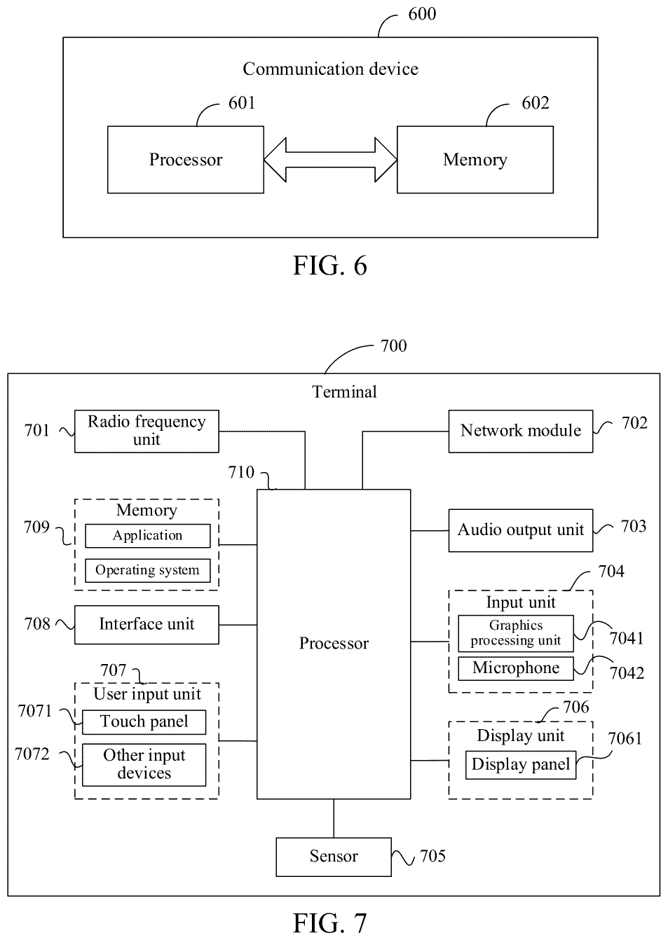

Optionally, as shown in FIG. 6, an embodiment of this application further provides a communication device 600, including a processor 601 and a memory 602. The memory 602 stores a program or instructions capable of running on the processor 601. For example, in a case that the communication device 600 is a terminal, when the program or instructions are executed by the processor 601, the steps in the method embodiment of FIG. 2 are implemented, with the same technical effect achieved. In a case that the communication device 600 is a network-side device, when the program or instructions are executed by the processor 601, the steps in the method embodiment of FIG. 3 are implemented, with the same technical effect achieved. To avoid repetition, details are not described herein again.

An embodiment of this application further provides a terminal, including a processor and a communication interface. The communication interface is configured to receive first indication information. The processor is configured to generate first channel feature information based on a first artificial intelligence AI network model, and determine target channel feature information based on the first indication information and the first channel feature information, where the first channel feature information includes the target channel feature information. The communication interface is further configured to report the target channel feature information. The terminal embodiment corresponds to the foregoing terminal-side method embodiment, and all implementation processes and implementations of the foregoing method embodiment are applicable to the terminal embodiment, with the same technical effect achieved. Specifically, FIG. 7 is a schematic diagram of a hardware structure of a terminal for implementing embodiments of this application.

The terminal 700 includes but is not limited to at least some of the following components: a radio frequency unit 701, a network module 702, an audio output unit 703, an input unit 704, a sensor 705, a display unit 706, a user input unit 707, an interface unit 708, a memory 709, a processor 710, and the like.

A person skilled in the art can understand that the terminal 700 may further include a power supply (for example, a battery) that supplies power to each component. The power supply may be logically connected to the processor 710 by using a power management system, to implement functions such as charging management, discharging management, and power consumption management by using the power management system. The terminal structure shown in FIG. 7 does not constitute a limitation on the terminal. The terminal may include more or fewer components than those shown in the figure, or some components may be combined, or there may be a different component layout. Details are not described herein again.

It should be understood that, in this embodiment of this application, the input unit 704 may include a graphics processing unit (GPU) 7041 and a microphone 7042. The graphics processing unit 7041 processes image data of a static picture or a video that is obtained by an image capture apparatus (for example, a camera) in a video capture mode or an image capture mode. The display unit 706 may include a display panel 7061. The display panel 7061 may be configured in a form of a liquid crystal display, an organic light-emitting diode, or the like. The user input unit 707 includes at least one of a touch panel 7071 and other input devices 7072. The touch panel 7071 is also referred to as a touchscreen. The touch panel 7071 may include two parts: a touch detection apparatus and a touch controller. The other input devices 7072 may include but are not limited to a physical keyboard, a function key (such as a volume control key or an on/off key), a trackball, a mouse, and a joystick. Details are not described herein.

In this embodiment of this application, after receiving downlink data from a network-side device, the radio frequency unit 701 may transmit the downlink data to the processor 710 for processing. In addition, the radio frequency unit 701 may transmit uplink data to the network-side device. Usually, the radio frequency unit 701 includes but is not limited to an antenna, an amplifier, a transceiver, a coupler, a low noise amplifier, a duplexer, and the like.

The memory 709 may be configured to store software programs or instructions and various data. The memory 709 may mainly include a first storage area for storing a program or instructions and a second storage area for storing data. The first storage area may store an operating system, an application or instructions required by at least one function (for example, an audio play function or an image play function), and the like. In addition, the memory 709 may include a volatile memory or a non-volatile memory, or the memory 709 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), or a direct rambus random access memory (DRRAM). The memory 709 in this embodiment of this application includes but is not limited to these and any other suitable types of memories.

The processor 710 may include one or more processing units. Optionally, the processor 710 integrates an application processor and a modem processor. The application processor mainly processes operations related to an operating system, a user interface, an application, and the like. The modem processor mainly processes wireless communication signals, for example, is a baseband processor. It can be understood that the modem processor may alternatively not be integrated in the processor 710.

The radio frequency unit 701 is configured to receive first indication information.

The processor 710 is configured to generate first channel feature information based on a first artificial intelligence AI network model, and determine target channel feature information based on the first indication information and the first channel feature information, where the first channel feature information includes the target channel feature information.

The radio frequency unit 701 is further configured to report the target channel feature information.

Optionally, the first indication information is used to indicate at least one of the following:
a length of the target channel feature information;
a length range of the target channel feature information;
a table index of a length of the target channel feature information; or
a location of the target channel feature information.

Optionally, the length of the target channel feature information is represented by at least one of the following:
an absolute length;
a preset proportion of a target length, where the target length is a maximum length of the first channel feature information generated based on the first AI network model; and
the number of base lengths, where the base length is agreed upon in a protocol.

Optionally, the first indication information includes at least one of the following:
RRC signaling;
MAC CE signaling; or
DCI.

Optionally, the first indication information is further used to indicate a payload size, and the processor 710 is further configured to:
determine the payload size based on the first indication information; and
determine a first length of the target channel feature information based on the payload size.

Optionally, the payload size is determined based on uplink resource and bit rate sizes configured by the network-side device.

Optionally, in a case that the first indication information performs implicit indication by using signaling, the first indication information is associated by using a channel state information CSI report configuration file, and the first indication information includes the table index of the length of the target channel feature information.

Optionally, the table index of the length of the target channel feature information is agreed upon in a protocol.

Optionally, in the table index of the length of the target channel feature information, one length of the target channel feature information corresponds to at least one parameter.

The parameter is related to at least one of the following:
the CSI report configuration file; or
a configuration of another reference signal that meets a quasi co-location QCL relationship with a CSI reference signal CSI-RS.

Optionally, the radio frequency unit 701 is further configured to:

report information content of the target channel feature information and the length of the target channel feature information.

Optionally, the first indication information is further used to indicate the terminal to report the length of the target channel feature information.

Optionally, the terminal includes L first AI network models, and L is a positive integer, where
any one of the L first AI network models corresponds to at least one length of the target channel feature information; or
the L first AI network models are in a one-to-one correspondence with L length ranges of the target channel feature information, and the L length ranges of the target channel feature information are different.

Optionally, a correspondence between any one of the L first AI network models and a length of the target channel feature information is configured by the network-side device; or
a correspondence between the L first AI network models and the L length ranges of the target channel feature information is configured by the network-side device.

Optionally, in a case that the first indication information includes the length of the target channel feature information, the processor 710 is further configured to:
determine a corresponding target first AI network model based on the length that is of the target channel feature information and that is indicated by the first indication information, and determine, based on the target first AI network model and the length of the target channel feature information, target channel feature information that needs to be reported; or
determine, based on the length that is of the target channel feature information and that is indicated by the first indication information, a length range of the target channel feature information to which the length belongs, determine a corresponding target first AI network model based on the length range of the target channel feature information, and determine, based on the target first AI network model and the length of the target channel feature information, target channel feature information that needs to be reported.

Optionally, in a case that the first indication information indicates a target length of the target channel feature information, and at least one length that is of the target channel feature information and that corresponds to each of at least two of the L first AI network models or a length range that is of the target channel feature information and that corresponds to each of the at least two first AI network models includes the target length, the processor 710 is further configured to:
select a target first AI network model based on the target length, and determine, based on the target first AI network model and the target length, target channel feature information that needs to be reported, where the target first AI network model is any one of the at least two first AI network models.

Optionally, the processor 710 is further configured to perform any one of the following:
selecting the target first AI network model based on the target length and priorities of the at least two first AI network models; or
in a case that the first indication information is further used to indicate the target first AI network model, selecting the target first AI network model based on the first indication information.

Optionally, the radio frequency unit 701 is further configured to:
report the target channel feature information and an index corresponding to the target first AI network model.

In this embodiment of this application, the terminal can process the channel information by using only one AI network model, and then flexibly obtain target channel feature information with different lengths based on the first indication information, without configuring a corresponding AI network model for channel feature information with each length, so that a capacity and power of the terminal can be effectively saved.

An embodiment of this application further provides a network-side device, including a processor and a communication interface. The communication interface is configured to send first indication information to a terminal, and receive target channel feature information reported by the terminal, where the target channel feature information is channel feature information determined by the terminal based on the first indication information and first channel feature information generated based on a first AI network model, and the first channel feature information includes the target channel feature information. The network-side device embodiment corresponds to the foregoing method embodiment for the network-side device, and all implementation processes and implementations of the foregoing method embodiment are applicable to the network-side device embodiment, with the same technical effects achieved.

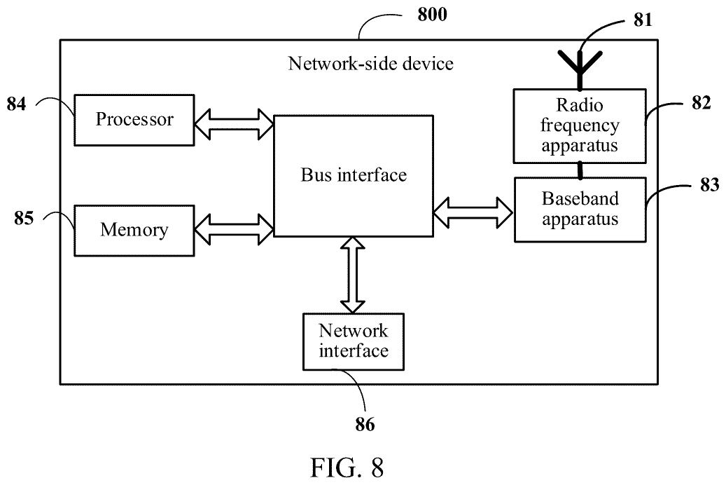

Specifically, an embodiment of this application further provides a network-side device. As shown in FIG. 8, the network-side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81, and transmits the received information to the baseband apparatus 83 for processing. In a downlink direction, the baseband apparatus 83 processes to-be-transmitted information, and transmits the information to the radio frequency apparatus 82; and the radio frequency apparatus 82 processes the received information and then transmits the information through the antenna 81.

The method performed by the network-side device in the foregoing embodiment may be implemented in the baseband apparatus 83, and the baseband apparatus 83 includes a baseband processor.

The baseband apparatus 83 may include, for example, at least one baseband board, where a plurality of chips are disposed on the baseband board. As shown in FIG. 8, one of the chips is, for example, the baseband processor, which is connected to the memory 85 through a bus interface, to invoke a program in the memory 85 to perform the operations of the network device shown in the foregoing method embodiments.

The network-side device may further include a network interface 86. The interface is, for example, a common public radio interface (CPRI).

Specifically, the network-side device 800 in this embodiment of the present invention further includes instructions or a program stored in the memory 85 and capable of running on the processor 84, and the processor 84 invokes the instructions or program in the memory 85 to perform the method performed by the modules shown in FIG. 6, with the same technical effect achieved. To avoid repetition, details are not described herein again.

An embodiment of this application further provides a readable storage medium. The readable storage medium stores a program or instructions. When the program or instructions are executed by a processor, the processes in the method embodiment of FIG. 2 are implemented, or the processes in the method embodiment of FIG. 3 are implemented, with the same technical effect achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions, to implement the processes in the method embodiment of FIG. 2, or implement the processes in the method embodiment of FIG. 3, with the same technical effect achieved. To avoid repetition, details are not described herein again.

It should be understood that the chip provided in this embodiment of this application may also be referred to as a system-level chip, a system on chip, a chip system, a system-on-a-chip, or the like.

An embodiment of this application further provides a computer program or program product. The computer program or program product is stored in a storage medium. The computer program or program product is executed by at least one processor to implement the processes in the method embodiment of FIG. 2, or implement the processes in the method embodiment of FIG. 3, with the same technical effect achieved. To avoid repetition, details are not described herein again.

An embodiment of this application further provides a communication system, including a terminal and a network-side device, where the terminal may be configured to perform the steps of the channel feature information transmission method in FIG. 2, and the network-side device may be configured to perform the steps of the channel feature information transmission method in FIG. 3.

It should be noted that the terms “include”, “comprise”, or any other variation thereof in this specification are intended to cover a non-exclusive inclusion, so that a process, a method, an object, or an apparatus that includes a list of elements not only includes those elements but also includes other elements that are not expressly listed, or further includes elements inherent to such a process, method, object, or apparatus. In absence of more constraints, an element preceded by “includes a . . . ” does not preclude the existence of other identical elements in the process, method, article, or apparatus that includes the element. In addition, it should be noted that the scope of the method and apparatus in the implementations of this application is not limited to performing functions in the shown or described order, but may also include performing functions in a substantially simultaneous manner or in a reverse order depending on the functions involved. For example, the described method may be performed in an order different from that described, and steps may be added, omitted, or combined. In addition, features described with reference to some examples may be combined in other examples.

According to the foregoing descriptions of the implementations, a person skilled in the art can clearly understand that the methods in the foregoing embodiments may be implemented by using software in combination with a necessary common hardware platform, or certainly may be implemented by using hardware. However, in most cases, the former is a preferred implementation. Based on such an understanding, the technical solutions of this application essentially or the part contributing to the conventional technology may be implemented in a form of a computer software product. The computer software product may be stored in a storage medium (for example, a ROM/RAM, a magnetic disk, or a compact disc), and includes several instructions for instructing a terminal (which may be a mobile phone, a computer, a server, an air conditioner, a network device, or the like) to perform the methods in the embodiments of this application.

The foregoing describes the embodiments of this application with reference to the accompanying drawings. However, this application is not limited to the foregoing specific implementations. The foregoing specific implementations are merely examples, but are not limitative. Inspired by this application, a person of ordinary skill in the art may further make many modifications without departing from the purposes of this application and the protection scope of the claims, and all the modifications shall fall within the protection scope of this application.

1. A channel feature information transmission method, comprising:
receiving, by a terminal, first indication information, and generating first channel feature information based on a first artificial intelligence (AI) network model;
determining, by the terminal, target channel feature information based on the first indication information and the first channel feature information, wherein the first channel feature information comprises the target channel feature information; and
reporting, by the terminal, the target channel feature information.

2. The method according to claim 1, wherein the first indication information is used to indicate at least one of the following:
a length of the target channel feature information;
a length range of the target channel feature information;
a table index of a length of the target channel feature information; or
a location of the target channel feature information.

3. The method according to claim 2, wherein the length of the target channel feature information is represented by at least one of the following:
an absolute length;
a preset proportion of a target length, wherein the target length is a maximum length of the first channel feature information generated based on the first AI network model; or
the number of base lengths, wherein the base length is agreed upon in a protocol.

4. The method according to claim 1, wherein the first indication information comprises at least one of the following:
radio resource control (RRC) signaling;
medium access control control element (MAC CE) signaling; or
downlink control information (DCI).

5. The method according to claim 1, wherein the first indication information is further used to indicate a payload size, and the determining, by the terminal, target channel feature information based on the first indication information and the first channel feature information comprises:
determining, by the terminal, the payload size based on the first indication information; and
determining, by the terminal, a first length of the target channel feature information based on the payload size.

6. The method according to claim 5, wherein the payload size is determined based on uplink resource and bit rate sizes configured by a network-side device.

7. The method according to claim 1, wherein in a case that the first indication information performs implicit indication by using signaling, the first indication information is associated by using a channel state information (CSI) report configuration file, and the first indication information comprises a table index of a length of the target channel feature information.

8. The method according to claim 2, wherein the table index of the length of the target channel feature information is agreed upon in a protocol.

9. The method according to claim 8, wherein in the table index of the length of the target channel feature information, one length of the target channel feature information corresponds to at least one parameter, wherein
the parameter is related to at least one of the following:
the CSI report configuration file; or
a configuration of another reference signal that meets a quasi co-location (QCL) relationship with a CSI reference signal (CSI-RS).

10. The method according to claim 1, wherein the reporting, by the terminal, the target channel feature information comprises:
reporting, by the terminal, information content of the target channel feature information and a length of the target channel feature information.

11. The method according to claim 10, wherein the first indication information is further used to indicate the terminal to report the length of the target channel feature information.

12. The method according to claim 1, wherein the terminal comprises L first AI network models, and L is a positive integer, wherein
any one of the L first AI network models corresponds to at least one length of the target channel feature information; or
the L first AI network models are in a one-to-one correspondence with L length ranges of the target channel feature information, and the L length ranges of the target channel feature information are different.

13. The method according to claim 12, wherein a correspondence between any one of the L first AI network models and a length of the target channel feature information is configured by a network-side device; or
a correspondence between the L first AI network models and the L length ranges of the target channel feature information is configured by a network-side device.

14. The method according to claim 12, wherein in a case that the first indication information comprises a length of the target channel feature information, the determining, by the terminal, target channel feature information based on the first indication information and the first channel feature information comprises:
determining, by the terminal, a corresponding target first AI network model based on the length that is of the target channel feature information and that is indicated by the first indication information, and determining, based on the target first AI network model and the length of the target channel feature information, target channel feature information that needs to be reported; or
determining, by the terminal based on the length that is of the target channel feature information and that is indicated by the first indication information, a length range of the target channel feature information to which the length belongs, determining a corresponding target first AI network model based on the length range of the target channel feature information, and determining, based on the target first AI network model and the length of the target channel feature information, target channel feature information that needs to be reported.

15. The method according to claim 12, wherein in a case that the first indication information indicates a target length of the target channel feature information, and at least one length that is of the target channel feature information and that corresponds to each of at least two of the L first AI network models or a length range that is of the target channel feature information and that corresponds to each of the at least two first AI network models comprises the target length, the determining, by the terminal, target channel feature information based on the first indication information and the first channel feature information comprises:
selecting, by the terminal, a target first AI network model based on the target length, and determining, based on the target first AI network model and the target length, target channel feature information that needs to be reported, wherein the target first AI network model is any one of the at least two first AI network models.

16. The method according to claim 15, wherein the selecting, by the terminal, a target first AI network model based on the target length comprises either of the following:
selecting, by the terminal, the target first AI network model based on the target length and priorities of the at least two first AI network models; or
in a case that the first indication information is further used to indicate the target first AI network model, selecting, by the terminal, the target first AI network model based on the first indication information.

17. The method according to claim 15, wherein the reporting, by the terminal, the target channel feature information comprises:
reporting, by the terminal, the target channel feature information and an index corresponding to the target first AI network model.

18. A channel feature information transmission method, comprising:
sending, by a network-side device, first indication information to a terminal; and
receiving, by the network-side device, target channel feature information reported by the terminal, wherein
the target channel feature information is channel feature information determined by the terminal based on the first indication information and first channel feature information generated based on a first AI network model, and the first channel feature information comprises the target channel feature information.

19. A terminal, comprising a processor and a memory, wherein the memory stores a program or instructions capable of running on the processor, wherein the program or instructions are executed by the processor, cause the terminal to perform:
receiving first indication information, and generating first channel feature information based on a first artificial intelligence (AI) network model;
determining target channel feature information based on the first indication information and the first channel feature information, wherein the first channel feature information comprises the target channel feature information; and
reporting the target channel feature information.

20. A network-side device, comprising a processor and a memory, wherein the memory stores a program or instructions capable of running on the processor, and when the program or instructions are executed by the processor, the steps of the channel feature information transmission method according to claim 18 are implemented.
